(19) United States
(12) Patent Application Publication
(10) Pub. No.: US 2017/0057185 A1
(43) Pub. Date: Mar. 2, 2017

(54) METHOD OF MAKING A BRIDGE OF EYEGLASSES

(71) Applicant: Oceanus Investment Inc., Mahe (SC)

(72) Inventor: David CHAO, Saratoga, CA (US)

(21) Appl. No.: 15/246,264

(22) Filed: Aug. 24, 2016

(30) Foreign Application Priority Data
Aug. 26, 2015 (TW) 104127918

(51) Int. Cl. B29D 12/02; B29C 45/40; B22F 1/00; B22F 3/00; B22F 3/10; B29C 45/00; B29C 45/26

(52) U.S. Cl. CPC B29D 12/02; B29C 45/0001; B29C 45/4005; B29C 45/26; B22F 3/004; B22F 3/10; B22F 1/0062; B29K 2105/16

(57) ABSTRACT

A method of making a bridge of eyeglasses includes the steps of: closing first and second mold cores to define therebetween a mold cavity having a shape corresponding to that of the bridge, the mold cavity having at least one injection hole communicating with an external environment; injecting metal clay through the at least one injection hole into the mold cavity at a high pressure to form a bridge blank; separating the first and second mold cores to expose the mold cavity and then ejecting the bridge blank from the mold cavity; and subjecting the bridge blank to a sintering process.

### CROSS REFERENCE TO RELATED APPLICATION

This application claims priority of Taiwanese Patent Application No. 104127918, filed on Aug. 26, 2015.

### FIELD

The disclosure relates to a method of making abridge of a pair of eyeglasses.

### BACKGROUND

As the life of modern people becomes richer, emphasizing fine workmanship on any article has become a trend. The same is true in the optical industry, whether it be a pair of lightweight rimless eyeglasses or a pair of highlighted rimmed eyeglasses, attention is given to the refinement of the bridge of the eyeglasses. A variety of production method is proposed as to how to connect the bridge to the lenses or lens frames.

Referring to FIG. 1, an existing pair of rimless eyeglasses 9 includes a pair of lenses 91, a bridge 92 having two opposite sides respectively connected to inner sides of the lenses 91, a pair of nose pads connected to the bridge 92, two end pieces 93 respectively connected to outer sides of the lenses 91, and two temples 94 respectively connected to the end pieces 93. When the rimless eyeglasses is worn by a user, the nose pads are disposed on two opposite sides of the user's nasal bridge, and the temples 94 are hooked on the user's ears, so that the lenses 91 are disposed in front of the user's eyes.

Since the bridge 92 is located at the center of the eyeglasses, it is especially conspicuous, so that the appearance of the bridge 92 becomes an important point in the manufacture thereof.

The method of making the bridge of the existing pair of eyeglasses includes using a metalworking process to form a metal sheet body, followed by cutting, bending, welding, etc. to form a shape similar to the bridge, and finally, grinding, electroplating, and other secondary processes are performed to form the bridge. However, cutting marks on an outer surface and the welding spots of the bridge made from the metalworking process cannot be prevented. Although these cutting marks can be concealed by electroplating, with the user wearing the eyeglasses regularly, the film of the electroplating is likely to fall off due to perspiration. Further, uneven thickness of the electroplating film is also a setback.

With the increasingly affluent lifestyle, the function of the eyeglasses gradually changes from vision adjustment to a fashion accessory. However, the issues regarding the cutting marks on the outer surface and the welding spots of the bridge and the uneven thickness of the electroplating films adversely affect the aesthetic appearance of the bridge, so that the willingness of the consumers to buy is reduced. How to develop a new manufacturing method that can enhance the fineness and maintain the delicate appearance of the bridge is a goal to be pursued by skilled personnel of this field.

### SUMMARY

Therefore, an object of the disclosure is to provide a method of making a bridge of eyeglasses.

According to this disclosure, a method of making a bridge of eyeglasses, in which the bridge includes a bridge frame that includes a bridge frame main body having a continuous smooth and undulating outer surface and an inner surface opposite to the outer surface, comprises the steps of: closing a first mold core and a second mold core to define therebetween a mold cavity having a shape corresponding to that of the bridge, the mold cavity having at least one injection hole communicating with an external environment, and a junction line that is formed when the first and second mold cores are closed and that corresponds to the inner surface of the bridge frame main body; injecting metal clay formed from a mixture of metal powder and polymer binder through the at least one injection hole into the mold cavity at a high pressure to form a bridge blank, the bridge blank including a blank bridge frame, a blank connecting protruding line and at least one injection eyelet, the blank bridge frame having a blank bridge frame main body, the blank bridge frame main body having a continuous smooth and undulating blank outer surface and a blank inner surface opposite to the blank outer surface, the blank connecting protruding line being located on the blank inner surface; separating the first and second mold cores to expose the mold cavity and then ejecting the bridge blank from the mold cavity; and subjecting the bridge blank to a sintering process.

### BRIEF DESCRIPTION OF THE DRAWINGS

Other features and advantages of the present disclosure will become apparent in the following detailed description of the embodiments with reference to the accompanying drawings, of which:

FIG. 1 is a perspective view of existing rimless eyeglasses;

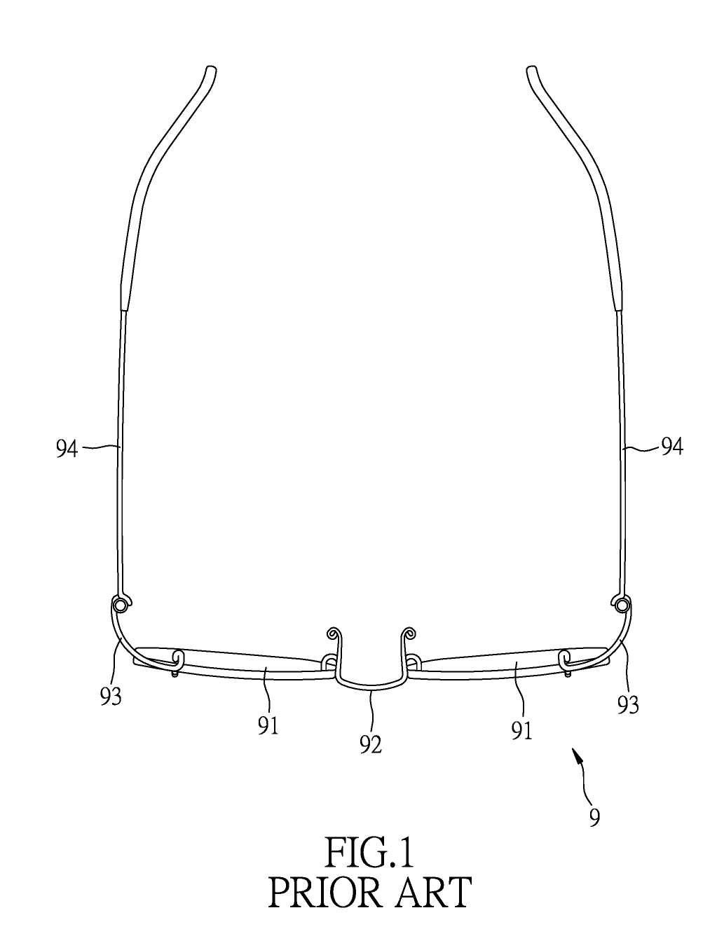

FIG. 2 is a flowchart illustrating the steps involved in a method of making a bridge according to the first embodiment of the present disclosure;

FIG. 3 is an exploded perspective view of a pair of eyeglasses incorporating the bridge made according to the method of the first embodiment;

FIG. 4 is a perspective view, illustrating first and second mold cores of a mold for making the bridge of the first embodiment being separated from each other and a bridge blank being ejected therefrom;

FIG. 5 is an exploded perspective view of a pair of lenses and a bridge that is made according to the method of the second embodiment of this disclosure; and

FIG. 6 is a perspective view, illustrating first and second mold cores of a mold for making the bridge of the second embodiment being separated from each other and a bridge blank being ejected therefrom.

### DETAILED DESCRIPTION

Before the present disclosure is described in greater detail with reference to the accompanying embodiment, it should be noted herein that like elements are denoted by the same reference numerals throughout the disclosure.

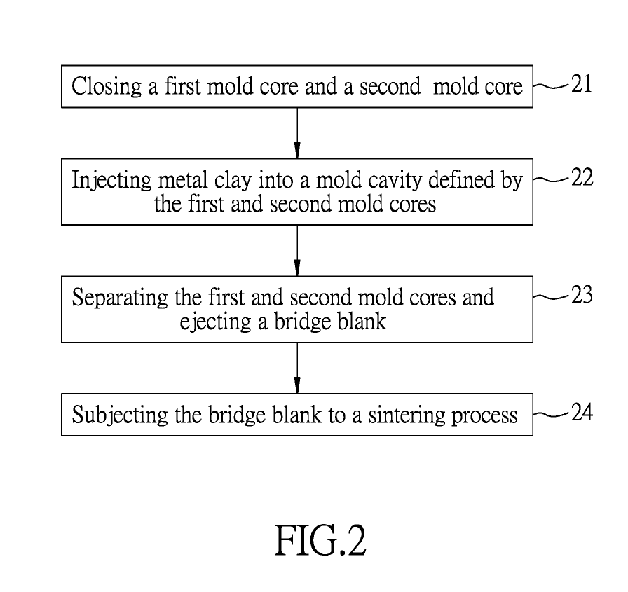

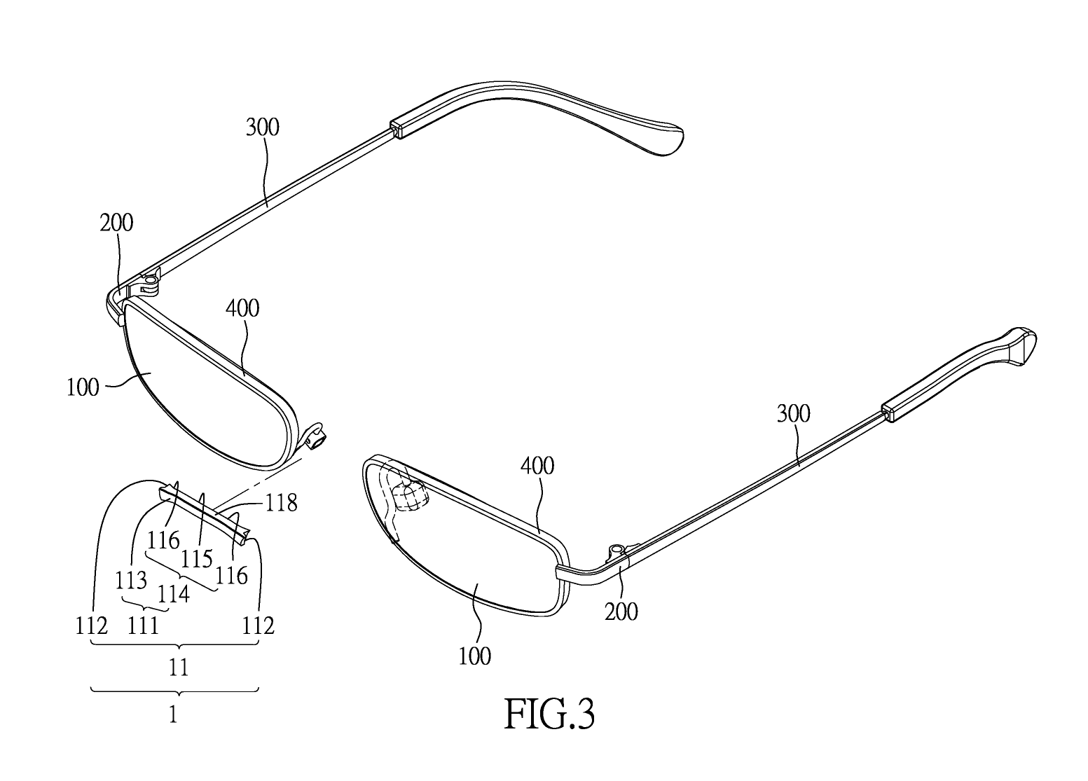

FIG. 2 illustrates the steps involved in a method of making a bridge according to the first embodiment of the present disclosure. The bridge 1 made according to the method of the first embodiment is configured to be connected between two lens frames 400 of rimmed eyeglasses, as shown in FIG. 3. The rimmed eyeglasses further includes a pair of lenses 100 respectively held in the lens frames 400, two temples 300, and two end pieces 200 each of which is connected between one of the lens frames 400 and a corresponding one of the temples 300.

With reference to FIG. 3, the bridge 1 made by the method of the first embodiment includes a bridge frame 11. The bridge frame 11 includes a bridge frame main body 111 and two connecting portions 112 respectively located at two opposite ends of the bridge frame main body 111. The bridge frame main body 111 has a continuous smooth and undulating outer surface 113, an inner surface 114 opposite to the outer surface 113, and two side surfaces 118 (only one is visible in FIG. 3) each of which interconnects one end of the outer surface 113 and a corresponding end of the inner surface 114. The inner surface 114 includes a middle section 115 having a curvature conforming to that of a user's nasal bridge, and two extension sections 116 extending outwardly and respectively from two opposite ends of the middle section 115. A junction between one end of the middle section 115 and the respective extension section 116 is rounded, and a junction between each side surface 118 and the corresponding one of the inner and outer surfaces 114, 113 is also rounded.

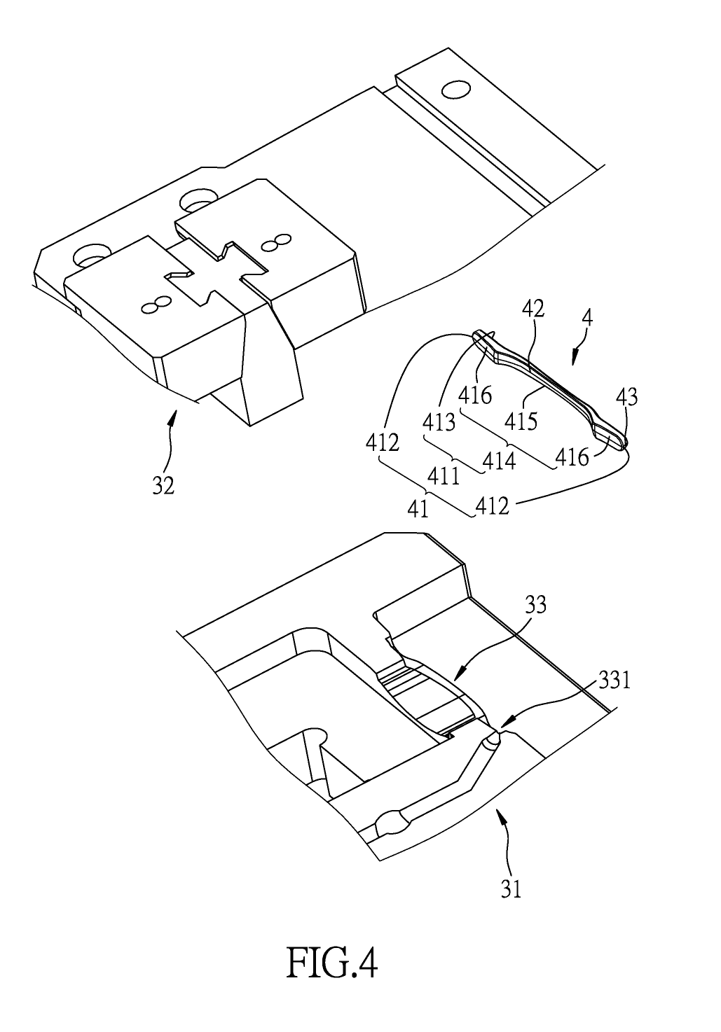

The method of making the bridge 1 according to the first embodiment includes steps 21 to 24, as shown in FIG. 2. The steps of the method of the first embodiment will be described in combination with FIGS. 3 and 4.

In step 21, a first mold core 31 and a second mold core 32 of a mold are closed to define therebetween a mold cavity 33 having a shape corresponding to that of the bridge 1. The mold cavity 33 has an injection hole 331 communicating with an external environment, and a junction line that is formed when the first and second mold cores 31, 32 are closed and that corresponds to the inner surface 114 of the bridge frame main body 111. The injection hole 331 is disposed at a position corresponding to one of the connecting portions 112. When the bridge 1 is connected to the lens frames 400, the trace of the injection hole 331 can be hidden in a junction between the bridge 1 and one of the lens frames 400. Because the trace of the injection hole 331 cannot be seen from the outside, the delicate appearance of the eyeglasses will not be affected.

The junction line is formed when the first and second mold cores 31, 32 contact each other. Considering the delicate appearance of the bridge 1 and the restrictions on casting processes, the junction line is disposed at a position corresponding to the center of a length direction of the inner surface 114 of the bridge frame main body 111 in order to facilitate subsequent surface treatment process which will be described in detail later.

In step 22, metal clay formed from a mixture of metal powder and polymer binder is injected through the injection hole 331 into the mold cavity 33 at a high pressure to form a bridge blank 4. The formed bridge blank 4 includes a blank bridge frame 41, a blank connecting protruding line 42, and an injection eyelet 43. The blank bridge frame 41 has a blank bridge frame main body 411 and two blank connecting portions 412. The blank bridge frame main body 411 has a continuous smooth and undulating blank outer surface 413, and a blank inner surface 414 opposite to the blank outer surface 413. The blank inner surface 413 includes a blank middle section 415 having a curvature conforming to that of a user's nasal bridge, and two blank extension sections 416 extending outwardly and respectively from two opposite ends of the blank middle section 415. Each of the blank connecting portions 412 is located on the blank inner surface 414 facing away from the blank outer surface 413. The blank connecting protruding line 42 is formed by a connecting line resulting from the injection of the metal clay into the mold cavity 33 when the first and second mold cores 31, 32 are closed, and is located on the blank inner surface 414. The injection eyelet 43 is located in one of the blank connecting portions 412 and corresponds to the injection hole 331.

In step 23, after the bridge blank 4 is cooled and set, the mold is opened by separating the first and second mold cores 31, 32 to expose the mold cavity 33, after which two spaced-apart ejector pins of a blank ejector module (not shown) are used to respectively contact the blank connecting portions 412 of the bridge blank 4 and form ejector pin contact positions for ejecting the bridge blank 4 from the first or second mold core 31, 32.

Since certain residual traces are left on the bridge blank 4 when the ejector pins contact the bridge blank 4 which affect the overall delicacy thereof, and when the contact pressures of the ejector pins are not uniform which may cause deformation of the bridge blank 4 during ejection, hence, in this step, the two ejector pin contact positions (not shown) are respectively restricted at the blank extension sections 416 in proximity to the respective blank connecting portions 412. As such, the bridge blank 4 receives a uniform contact force from the ejector pins. Further, the contact points are hidden when welded to the lens frames 400 and are not visible from the outside, so that the overall delicate appearance of the product can be maintained.

Finally, in step 24, the bridge blank 4 is subjected to a sintering process and a surface treatment process to obtain the bridge 1. In further details, the bridge blank 4 is first sintered, after which it undergoes the surface treatment process, such as polishing, grinding, blunting, electroplating and PVD (Physical Vapor Deposition) coating. After the blank connecting protruding line 42 is eliminated, the bridge 1 obtained has the outer surface 113 and the inner surface 114 that are completely flawless.

After completing the aforementioned steps, the bridge 1 is welded to the lens frames 400, two nose pieces are respectively welded to the lens frames 400, and the end pieces 200 and the temples 300 are assembled to the lens frames 400 by using a fastening or engaging method, thereby completing assembly of the rimmed eyeglasses. Since the method of making the bridge for the eyeglasses according to the present disclosure is different from the manufacturing method of the components of the existing eyeglasses, the produced bridge frame main body 111 completely has no sharp corners or edges, no traces of welding, and will not have the issue of non-uniformity of electroplating layers. In addition, the injection eyelet 43 and the contact positions of the ejector pins, which cannot be prevented during the manufacturing process and which can affect the delicate appearance of the eyeglasses, are all hidden in the junction between the bridge 1 and the corresponding lens frame 400, so that the bridge 1 having smooth and aesthetic outer and inner surfaces 113, 114 can be made and obtained.

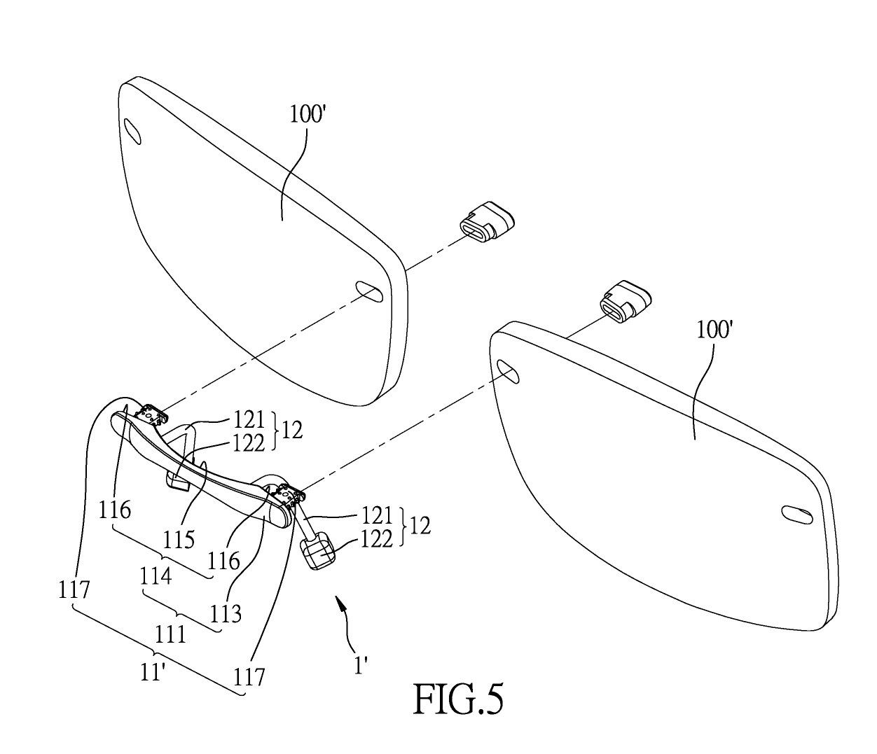

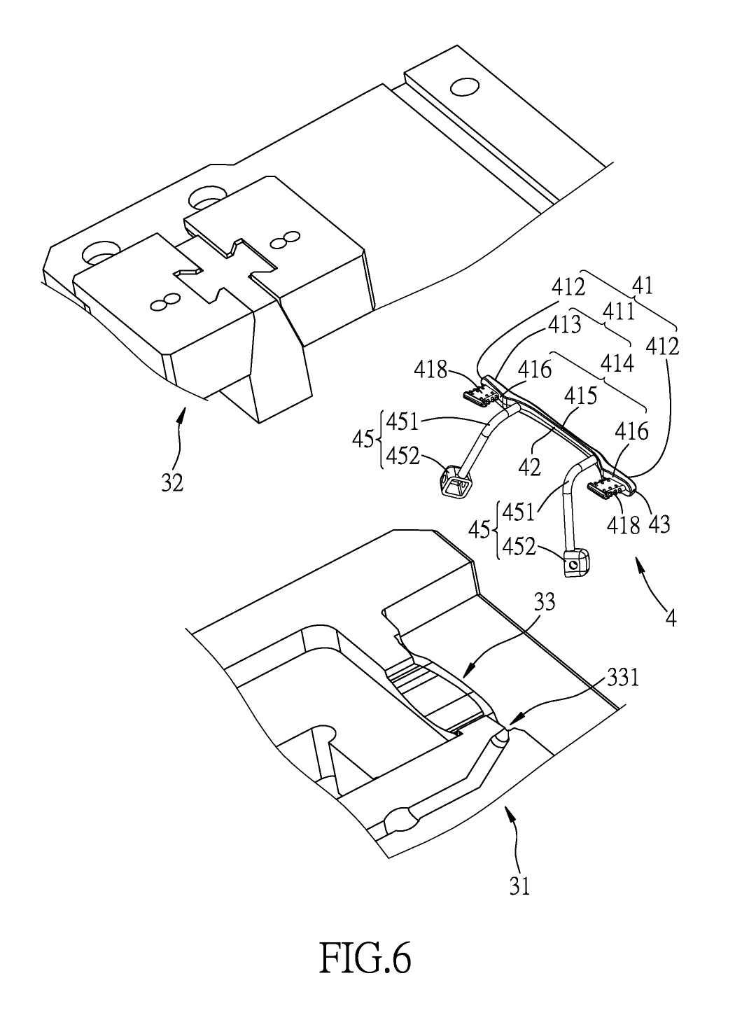

Referring to FIGS. 5 and 6, abridge 1′ made according to the method of the second embodiment of this disclosure is configured to be connected between a pair of lenses 100′ of a pair of rimless eyeglasses. The bridge 1′ manufactured by the second embodiment is generally identical to that of the first embodiment. However, in this embodiment, the bridge 1′ further includes two nose pad supports 12, and the bridge frame 11′ thereof further includes two engaging members 117 to replace the connecting portions 112 of the first embodiment.

Each of the nose pad supports 12 extends from the middle section 115 of the inner surface 114 of the bridge frame main body 111, and has a suspending portion 121 connected to the bridge frame main body 111, and a supporting portion 122 connected to the suspending portion opposite to the bridge frame main body 111 for supporting a nose pad. The engaging members 117 are located on the extension sections 116 of the inner surface 114, and protrude in a direction away from the outer surface 113 for respective engagement with reserved holes in inner sides of the lenses 100′. When the bridge 1′ is assembled to the lenses 100′, the two engaging members 117 are hidden in the respective reserved holes, so that when the user wears the rimless eyeglasses, the engaging members 117 are not visible from the outside of the rimless eyeglasses, and only a delicate and continuous smooth and undulating outer surface 113 of the rimless eyeglasses is visible.

The steps of the method of the second embodiment are generally identical to those described in FIG. 2 of the first embodiment. To produce the bridge 1′ of the second embodiment, in step 21, the injection hole 331 of the mold cavity 33 is disposed at a position corresponding to one of the engaging members 117 or one of the supporting portions 122. When the bridge 1′ is connected to one the lenses 100′ or one of the nose pad supports 12, the trace of the injection hole 331 is hidden in a junction between the bridge 1′ and the corresponding one of the lenses 100′ or the corresponding one of the nose pad supports 12. Because the trace of the injection hole 331 is not visible from the outside, the delicate appearance of the eyeglasses will not be affected. In this embodiment, the injection hole 331 is exemplified as being disposed at a position corresponding to one of the engaging members 117.

Further, in step 22, the formed bridge blank 4 further includes two blank nose pad supports 45, and the blank bridge frame 41 further has two blank engaging members 418 which replace the blank connecting portions 412 of the first embodiment. Each of the blank nose pad supports 45 extends from the blank bridge frame main body 411, and includes a blank suspending portion 451 connected to the blank bridge frame main body 411, and a blank supporting portion 452 connected to the blank suspending portion 451 opposite to the bridge frame main body 411 for supporting the nose pad. Each of the blank engaging members 418 is located on the blank inner surface 414, and protrude in a direction away from the blank outer surface 413. The injection eyelet 43 is located in one of the blank engaging members 418 or one of the blank supporting portions 452 of the blank nose pad supports 45, and corresponds to the injection hole 331. In this embodiment, the injection eyelet 43 is exemplified as being located in one of the blank engaging members 418.

In step 23, the two ejector pin contact positions are restricted in the respective blank engaging members 418, so that the bridge blank 4 receives a uniform force from the ejector pins, and the contact points are hidden at locations not visible from the outside after assembly of the rimless eyeglasses. As such, the overall delicate appearance of the product can be maintained.

Referring again to FIG. 5, after the foregoing steps are completed, the bridge 1′ can be connected to the lenses 100′ by using a fastening or engaging method, thereby completing the assembly of the rimless eyeglasses.

In sum, the method of making the bridge 1, 1′ of the eyeglasses of the present disclosure employs the cooperation of the first and second mold cores 31, 32 and the metal clay injection in step 22 to hide the blank connecting protruding line 42 in the blank inner surface 414 which is not visible from the outside and to hide the injection eyelet 43 in the welding or engaging place. In addition, by placing the ejector pin contact positions at the corresponding junctions, traces of the ejector pin contact positions can be hidden after welding or engaging. Hence, the produced bridge 1, 1′ can meet the demand of the new era, and has an aesthetic and delicate appearance. Therefore, the object of this disclosure can be realized.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIG., or description thereof for the purpose of streamlining the disclosure and aiding in the understanding of various inventive aspects.

While the present disclosure has been described in connection with what are considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of making a bridge of eyeglasses, the bridge including a bridge frame, the bridge frame including a bridge frame main body having a continuous smooth and undulating outer surface and an inner surface opposite to the outer surface, said method comprising the steps of:
closing a first mold core and a second mold core of a mold to define therebetween a mold cavity having a shape corresponding to that of the bridge, the mold cavity having at least one injection hole communicating with an external environment, and a junction line that is formed when the first and second mold cores are closed and that corresponds to the inner surface of the bridge frame main body;
injecting metal clay formed from a mixture of metal powder and polymer binder through the at least one injection hole into the mold cavity at a high pressure to form a bridge blank, the bridge blank including a blank bridge frame, a blank connecting protruding line and at least one injection eyelet, the blank bridge frame having a blank bridge frame main body, the blank bridge frame main body having a continuous smooth and undulating blank outer surface and a blank inner surface opposite to the blank outer surface, the blank connecting protruding line being located on the blank inner surface;
separating the first and second mold cores to expose the mold cavity and then ejecting the bridge blank from the mold cavity; and
subjecting the bridge blank to a sintering process.

2. The method as claimed in claim 1, wherein the bridge further includes two nose pad supports extending from the bridge frame main body, the bridge frame further having two engaging members located on two opposite ends of the bridge frame main body, and wherein, in the step of injecting the metal clay, the bridge blank further includes two blank nose pad supports extending from the blank bridge frame main body, the blank bridge frame further having two blank engaging members extending from the blank inner surface in a direction away from the blank outer surface.

3. The method as claimed in claim 2, wherein, when the first and second mold cores are closed, the at least one injection hole is located at a position corresponding to one of the engaging members.

4. The method as claimed in claim 2, wherein each of the nose pad supports further has a suspending portion connected to the bridge frame main body, and a supporting portion connected to the suspending portion opposite to the bridge frame main body for supporting a nose pad, and wherein, when the first and second mold cores are closed, the at least one injection hole is located at a position corresponding to the supporting portion.

5. The method as claimed in claim 1, wherein the bridge frame further includes two connecting portions respectively located at two opposite ends of the bridge frame main body, and wherein, when the first and second mold cores are closed, the at least one injection hole is located at a position corresponding to one of the connecting portions.

6. The method as claimed in claim 5, wherein the blank bridge frame further has two blank connecting portions located at two opposite ends of the blank bridge frame main body.

7. The method as claimed in claim 1, further comprising the step of subjecting the bridge blank to a surface treatment process after the sintering process.
